(19) United States
(12) Patent Application Publication
(10) Pub. No.: US 2026/0287885 A1
(43) Pub. Date: Sep. 24, 2026

(54) LUNAR CORONAGRAPH

(71) Applicant: Arizona Board of Regents on Behalf of the University of Arizona, Tucson, AZ (US)

(72) Inventors: Vishnu Reddy Kanuouru, Tucson, AZ (US); Scott Tucker, Tucson, AZ (US)

(21) Appl. No.: 19/572,090

(22) Filed: Mar. 19, 2026

Related U.S. Application Data
(60) Provisional application No. 63/775,276, filed on Mar. 20, 2025.

(51) Int. Cl. G02B 26/02; B64G 3/00; G02B 23/06; G02B 23/16; H04N 23/55

(52) U.S. Cl. CPC G02B 26/023; B64G 3/00; G02B 23/06; G02B 23/16; H04N 23/55

(57) ABSTRACT

Lunar coronagraphs are described that produce high-quality images and have a compact design, without requiring refractive elements. One example lunar coronagraph includes a primary mirror and a secondary mirror positioned on an optical axis facing each other. The primary mirror receives moonlight in an on-axis configuration and directs the received moonlight to the secondary mirror. The focal plane of the primary mirror is located between the primary mirror and the secondary mirror, and the primary mirror includes an opening at its center to allow light that is reflected from the secondary mirror to exit. The coronagraph also includes an occulting disk at the focal plane of the primary mirror, and a mask positioned after the occulting disk that blocks or reduces diffraction artifacts associated with the occulting disk. The chronograph additionally includes a baffle between the mask and the primary mirror that reduces or eliminates stray light.

### CROSS-REFERENCE TO RELATED APPLICATION(S)

This application claims priority to the provisional application with Ser. No. 63/775,276 titled “LUNAR CORONAGRAPH,” filed Mar. 20, 2025. The entire contents of the above noted provisional application are incorporated by reference as part of the disclosure of this document.

### TECHNICAL FIELD

The technology described in this patent document relates to methods, devices and systems for observation and imaging of the moon and nearby objects.

### BACKGROUND

A lunar coronagraph is an optical instrument that blocks out the direct light from the moon, enabling the observation of the area around the moon, including nearby objects (e.g., satellites, space crafts, etc.), as well as analysis of lunar exosphere without the direct interfering effects of moonlight. The existing lunar chronographs suffer from aberrations that can degrade image quality due to the presence of refractive optical components that are often positioned at the back end of the chronograph, which also adds to the physical size of the chronograph.

### SUMMARY

The disclosed embodiments, among other features and benefits, describe lunar coronagraphs that produce high image quality and have a compact design, without requiring additional refractive elements.

One example lunar coronagraph includes a primary mirror and a secondary mirror positioned on an optical axis and facing each other, where the primary mirror is positioned to receive moonlight in an on-axis configuration and to direct the received moonlight to the secondary mirror, the primary mirror includes an opening in a center thereof to allow light that is reflected from the secondary mirror to exit therethrough, and a focal plane of the primary mirror is positioned at a location within the lunar coronagraph between the primary mirror and the secondary mirror. The lunar coronagraph also includes an occulting disk positioned at the focal plane of the primary mirror to block a portion of the moonlight corresponding to at least a portion of moon that is within a field of view of the lunar coronagraph, a mask positioned in an optical path after the occulting disk, the mask configured to block or reduce a diffraction artifact associated with the occulting disk, and a baffle positioned on the optical axis between the mask and the primary mirror to reduce or eliminate stray light associated with the moonlight that enters the lunar coronagraph.

### BRIEF DESCRIPTION OF THE DRAWINGS

FIG. 1 illustrates an example diagram of a classical lunar coronagraph.

FIG. 2 illustrates a lunar coronagraph configuration in accordance with an example embodiment.

FIG. 3 illustrates a lunar coronagraph configuration in accordance with another example embodiment.

FIG. 4 illustrates a detailed view of a mechanical fixture used for accommodating the secondary lens, the occulting disk and the Lyot mask of a lunar coronagraph in accordance with an example embodiment.

FIG. 5 is an illustration, showing the movement of the moon within the field of view of a lunar coronagraph in accordance with some example embodiments.

FIG. 6 illustrates an occulting disk diagram for a lunar coronagraph in accordance with an example embodiment.

FIG. 7 shows a Lyot stop diagram for a lunar coronagraph in accordance with an example embodiment.

FIG. 8 illustrates a focus and pupil diagram, showing the on-axis and off-axis ray trace for a lunar chronograph in accordance with an example embodiment.

### DETAILED DESCRIPTION

In terms of its general functionality, a lunar coronagraph is similar to its counterpart solar coronagraph, which is engineered to block out the direct light from the sun's photosphere (the bright surface of the sun), allowing the much fainter corona to be observed. However, due to the high intensity of sunlight, solar and lunar coronagraph implementations are considerably different. For example, solar coronagraphs require heat dissipation (or cooling), are implemented in an off-axis configuration, and must include refractive components.

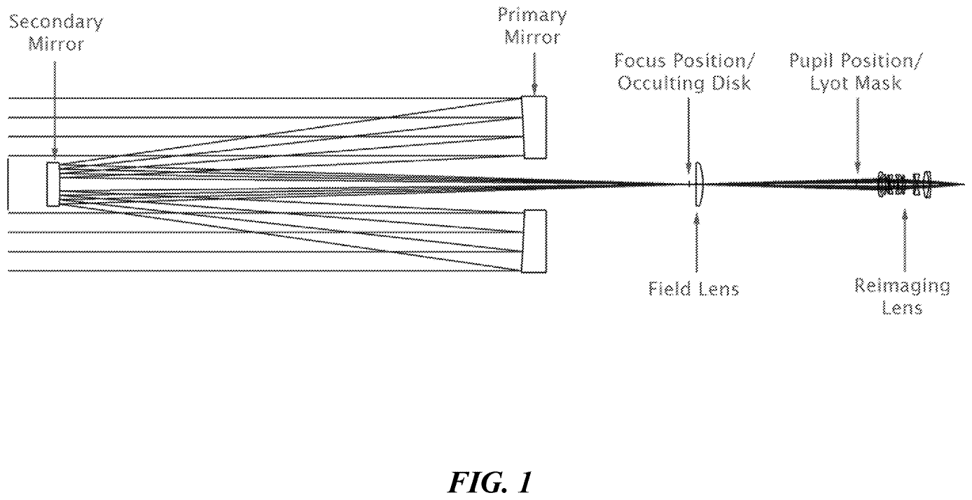

FIG. 1 illustrates an example diagram of a classical lunar coronagraph, which is implemented as an attachment or add-on components of a telescope. Referring to FIG. 1, moonlight enters the telescope from the left, and is collected by the primary mirror, which directs the collected light to the secondary mirror. The light after reflection from the secondary mirror passes through the opening in the middle of the primary mirror and comes to focus at a focus position outside (to the left) of the telescope. An occulting disk is positioned at the focus position to obscure the moon's bright light. A field lens is positioned after the occulting disk that reimages the pupil of the primary mirror. A Lyot mask is positioned in the optical path further to the left of the field lens to eliminate the tails of the diffraction pattern at the pupil plane. Notably, the occulting mask blocks the core of the point spread function (PSF), and the diffracted light in the wings of the PSF is apodized by the Lyot mask (or sometime called a Lyot stop). Together, the occulting mask and Lyot mask eliminate or considerably reduce the effects of the bright moonlight, and allow faint features near the moon to be observed. The configuration in FIG. 1 further includes a reimaging lens section that includes multiple optical components to image the focal plane and create a new image at a detector/imaging sensor (not shown), with the moon occulted.

An advantage of the lunar coronagraphs of FIG. 1 is the ability to be adapted to an existing telescope without the need for a custom telescope. However, the configuration in FIG. 1 requires multiple refractive elements and a complex optical design. This can lead to more scattering by the multiple optical surfaces, and aberrations that can degrade image quality. Additionally, the back end is mechanically much longer, which requires additional space and can lead to flexure issues.

The disclosed embodiments, among other features and benefits, address the above shortcomings of existing lunar coronagraphs, and produce a more compact design, without requiring additional refractive elements.

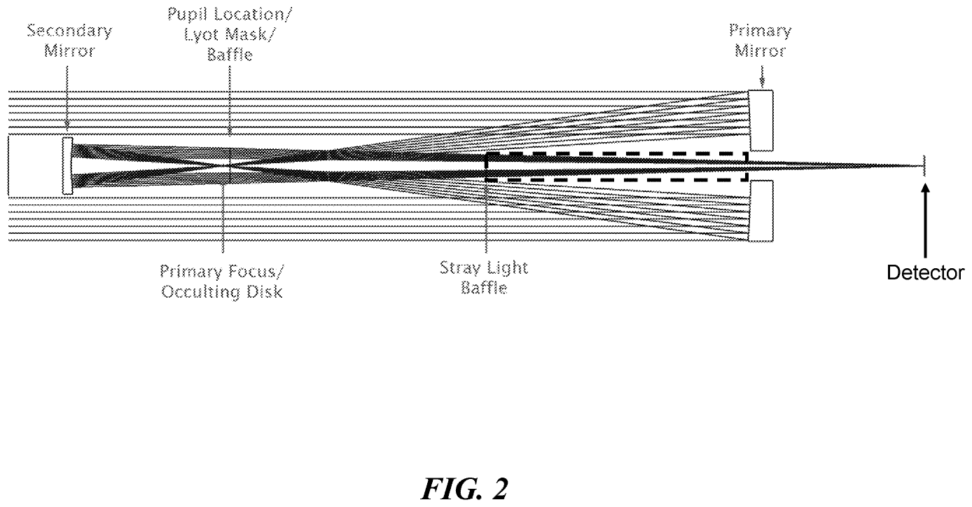

FIG. 2 illustrates a lunar coronagraph configuration in accordance with an example embodiment. The example coronagraph shown in FIG. 2 leverages a Gregorian telescope configuration wherein the primary focus is positioned inside the telescope. Notably, in the configuration of FIG. 2, moonlight enters the telescope from the left, is collected by the primary mirror and is reflected to the secondary mirror after coming to a focus at the focus position between the primary and secondary mirrors. An occulting disk is positioned at the focus position to obscure the moon's bright light. A Lyot mask is positioned in the optical path of the moonlight after (to the right of) the primary focus/occulting mask to mitigate the PSF sidelobes. In other words, the secondary mirror reimages the pupil of the primary mirror that lets the Lyot mask eliminate the tails of the diffraction pattern from primary. The secondary mirror also reimages the focal plane to create a new image where the moon is occulted. A stray light baffle is positioned between the Lyot mask and the primary mirror (central hole in the primary) to eliminate or reduce stray light contamination of the output light due to (1) moonlight that enters the telescope from the left, and/or (2) light reflected from the primary mirror and other components and walls inside of the coronagraph. A detector is positioned outside of the telescope at a focal plane of the secondary mirror; the detector is coupled to a processing unit that processes the received signals to generate image data.

Some advantages of the lunar coronagraph of FIG. 2 include its simple optical design that includes only two reflective surfaces and no refractive elements, which minimize scattering due to fewer optical surfaces. The relatively simple design allows easy construction of the coronagraph in a compact form in comparison to the more complicated adaptations of exiting telescopes that include multiple refractive elements and require additional real estate outside of the telescope. It should be noted that the coronagraph configurations of the disclosed embodiments are operable in an on-axis configuration, wherein the moonlight is received directly from moon, and provided to the detector on the same axis.

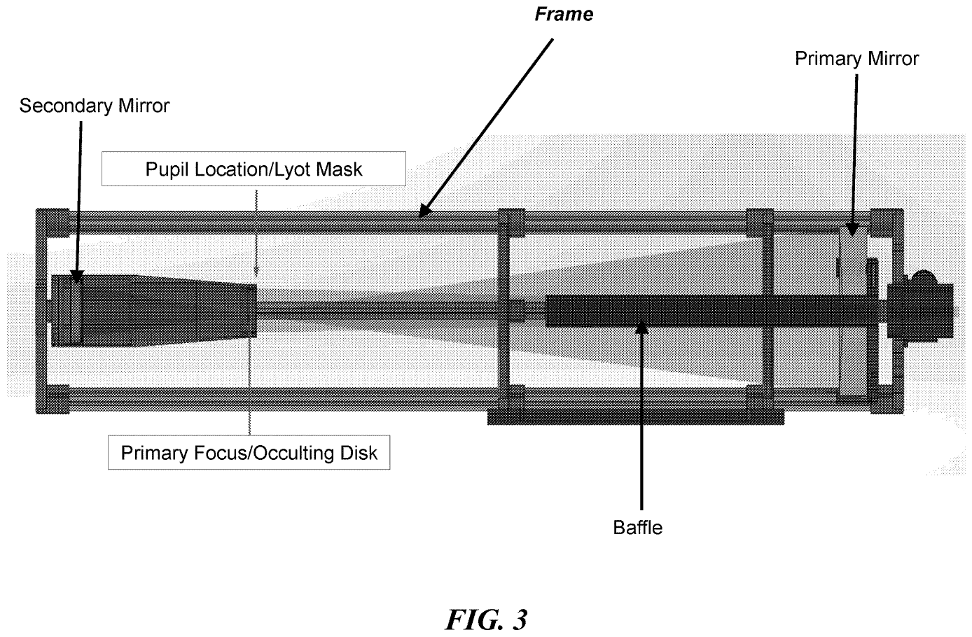

FIG. 3 illustrates a lunar coronagraph configuration in accordance with another example embodiment. The general layout of the components in FIG. 3 is similar to that in FIG. 2, but FIG. 3 also illustrates the coronagraph frame and other fixtures that accommodate the various components. The lunar coronagraph configuration of FIG. 3 was constructed using an existing primary mirror of a Gregorian telescope; in particular, an 8-inch F/3.5 parabolic primary was selected, and a 40 mm hole was bored in its center. A custom secondary was fabricated to match the primary specifications. In particular, the secondary mirror was a 60 mm concave ellipsoid with F/5.71. The final focal ratio was F/20 (Focal length: 4000 mm). Both optical components (mirrors) were made of regular Pyrex glass with the proper reflective coatings. Mechanical components of the example lunar coronagraph were 3D-printed. Alternatively, some or all of the mechanical components can be made of 80:20 aluminum.

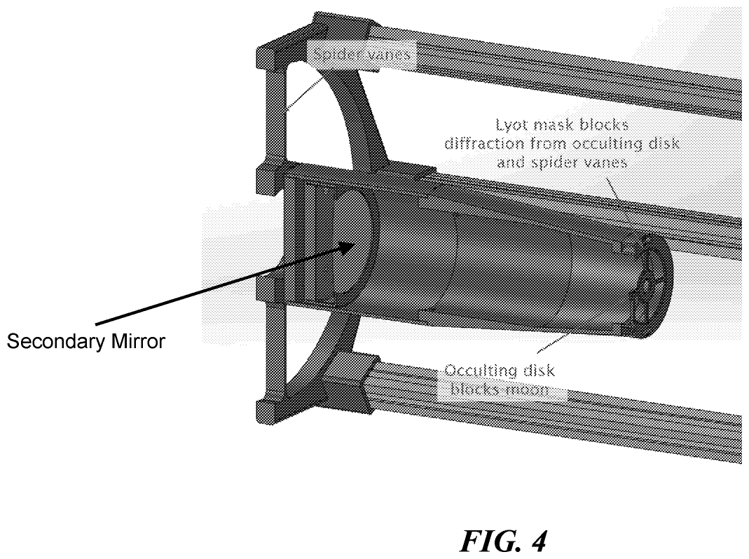

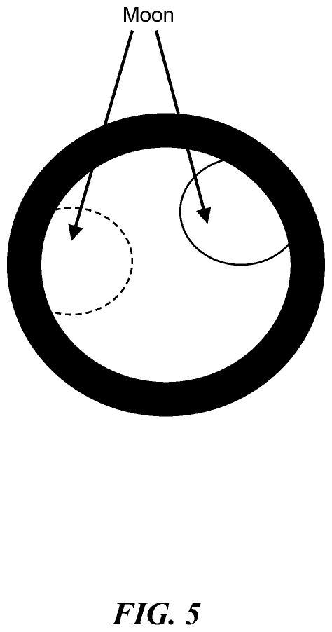

FIG. 4 illustrates a more detailed view of a mechanical fixture used for accommodating the secondary lens, the occulting disk and the Lyot mask in accordance with an example embodiment. The fixture can be 3D-printed in some example implementations. The locations of the secondary mirror, the occulting disk and the Lyot mask are identified in FIG. 4. Notably, the Lyot mask blocks both the PSF sidelobes (due to the presence of the occulting mask) and the diffraction artifacts produced by the spider vanes at the telescope entrance. The field of view of this example lunar coronagraph is smaller than the full disk (0.5 deg) of the moon. The imaging sensor can be a CCD sensor, for example. With a full frame sensor (e.g., IMX455), we obtained a field of view of 30′×20′ and a pixel scale of 0.19″/pixel. During imaging, the occulting disk needs to be manipulated (e.g., moved in the plane perpendicular to the optical axis) so it can block the moonlight to allow imaging of the region of interest. For example, as illustrated in FIG. 5, the moon may appear in different locations within the field of view of the coronagraph (shown by the solid and dashed circles); to block the direct moonlight, the occulting disk must therefore be laterally shifted to block the direct moonlight, depending on the location of the moon (or a section thereof) within the field of view. Movement of the occulting disk can be done manually, or alternatively, using a stepper motor to orient the occulting disk during imaging.

The lunar coronagraph is able to successfully detect faint objects around the moon, including faint satellites very close to the moon. For example, Queqiao-2 relay satellite was successfully detected at an angular distance of 2.8 degrees from the moon, at a visual magnitude of 18.7. These results are provided merely by the way of example, and not by limitation.

The disclosed lunar coronagraphs can be earth-based or spaceborne, and can be used to detect and/or image satellites, space crafts, and other terrestrial objects, as well as to detect and/or analyze the lunar exosphere, including trace elements therein.

One example set of optical design parameters for the components of the lunar coronagraph is shown in Table below. The occulting disk and focal plane diameters are based on angular diameter of the full moon.

| | | | Distance from | | | |
|---|---|---|---|---|---|---|
| | Radius of | | Previous | | | |
| Optical Surface | Curvature | | Surface | | Diameter | |
| Primary Mirror | −1422 | mm | — | | 203 | mm |
| Primary Focus/ | — | | −711 | mm | 6.3 | mm |
| Occulting Disk | | | | | | |
| Secondary Mirror | 347 | mm | −204.3 | mm | 60 | mm |

| | | | | | |
|---|---|---|---|---|---|
| Pupil/Lyot Stop | — | 214.1 | mm | 42 | mm |
| Focal Plane | — | 935.5 | mm | 36 | mm |

It should be noted the above configurations and parameters have been described by the way of example, and not by limitation. Accordingly, depending on the final specifications and application requirements, the disclosed configurations may be modified to provide the required performance. For instance, the final focal ratio is dictated by the focal length of the primary mirror. Hence, a faster primary (e.g., F/2.5) can be used to build a faster system (e.g., F/10). This makes the coronagraph physically smaller and provides a larger field of view with a given sensor. Other example configurations can include a 30″ F/2.5 primary with a final focal ratio of F/10. Such a configuration provides a three-magnitude advantage over the above-noted 8-inch prototype (FOV: 16′×11″; Pixel Scale: 0.1″/pixel).

As shown in FIGS. 2 and 3, the depicted lunar coronagraph configurations include a baffle that is positioned to remove stray light. The left end of the baffle is positioned between the Lyot mask and the central hole of the primary mirror, where the light exits in the direction of the imaging sensor. In some embodiments, the baffle has a uniform cross-sectional diameter across its entire length. The cross-sections diameter and the length of the diameter depend at least in part on the focal characteristics of primary mirror. Notably, the baffle diameter must be dimensioned such that it does not block the light that propagates from the primary to the secondary mirror. Accordingly, a faster primary lens necessitates a baffle with a smaller diameter, while a slower primary allows a large baffle diameter.

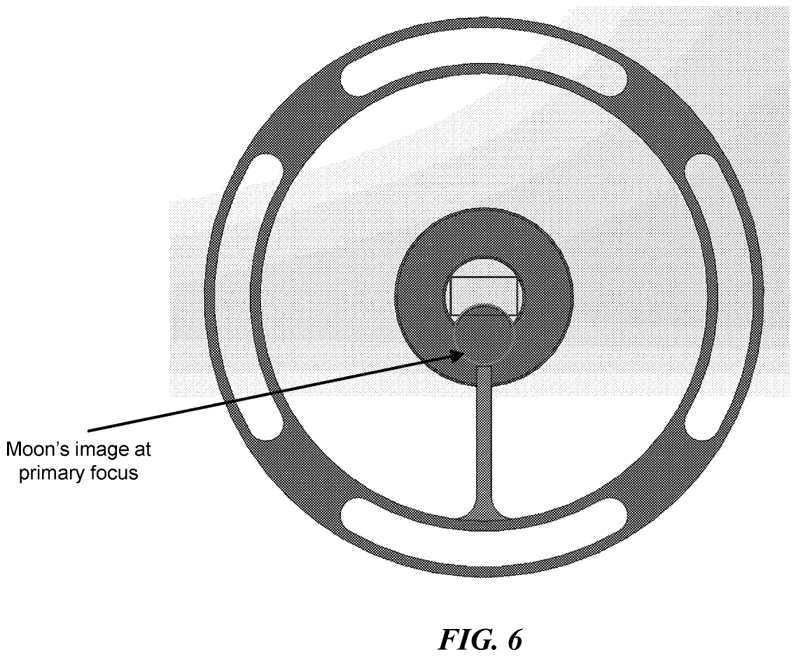

FIG. 6 illustrates an example occulting disk diagram, where the small circle that is offset from the center of the diagram represents the size of the image of the moon at the focus of the primary mirror. The rectangle at the center of the diagram represents the size of the camera detector used in one example implementation but this can vary based on the overall design. The moon is offset from the center of the field and a hole in the disk passes light from the target area near the moon to the detector. The disk can be rotated depending on the orientation of the target area relative to the moon.

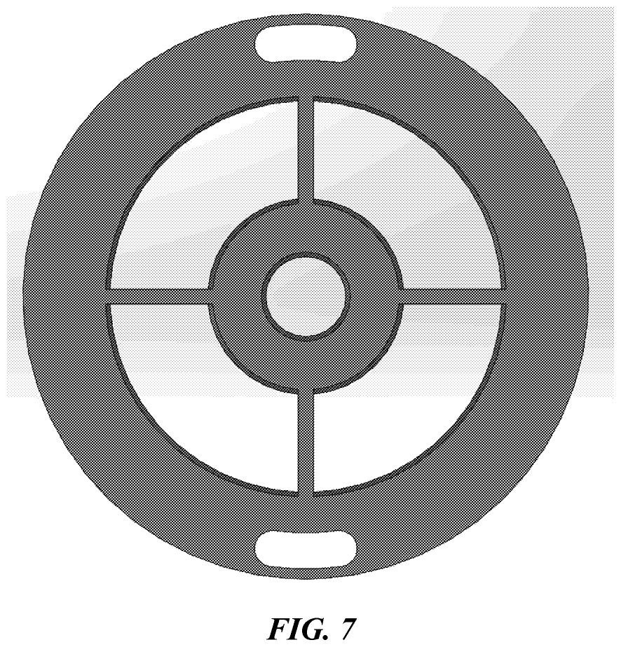

FIG. 7 shows an example Lyot stop diagram. It includes two nested circular cutouts. The outer is the Lyot stop, placed at the internal pupil of the telescope, and is slightly undersized relative to the pupil diameter to eliminate diffracted light created by the telescope aperture and occulting disk. A central opaque disk (annulus) and four support arms can be used to minimize the diffraction effects of the secondary mirror obstruction and the spider vanes that support the secondary mirror. A hole is required in the center of that disk to pass the converging light from the primary mirror since the Lyot stop is located slightly closer to the primary mirror than the occulting disk.

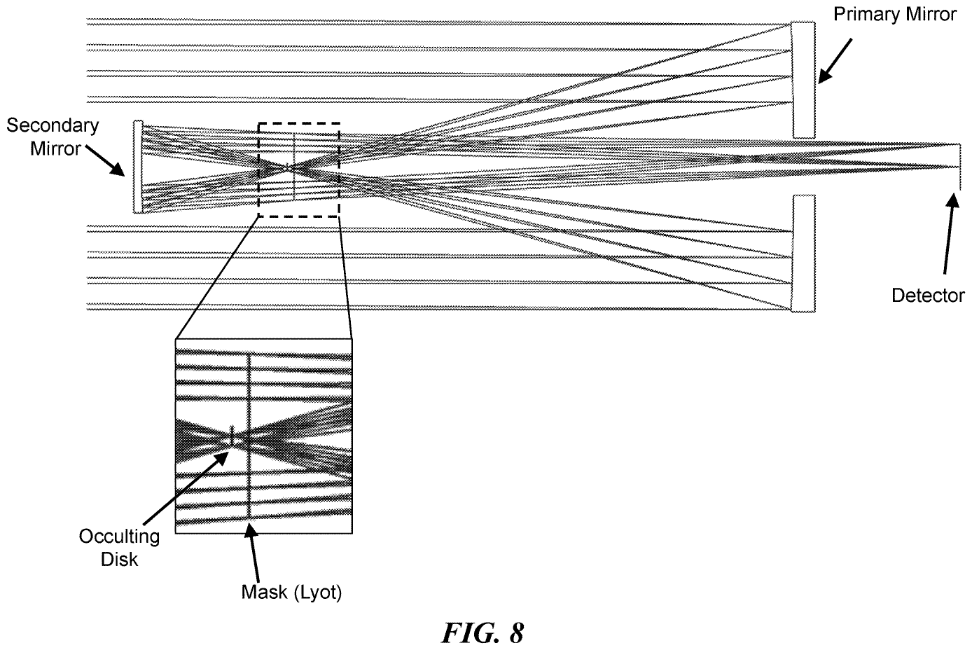

FIG. 8 illustrates a focus and pupil diagram, showing the on-axis and off-axis ray trace of the optical system. It is exaggerated 2× in height for clarity, and the inset provides an enlarged view of the primary focus, occulting disk and Lyot mask. The light reaches the intermediate focus between the primary and secondary mirror, where the occulting disk is located. The off-axis light from the full diameter of the moon determines the size of the intermediate focal plane and mask. After being reflected by the secondary mirror, the on-axis and off-axis beams coincide in diameter at the location of the pupil and Lyot stop. The exact diameter of the pupil is determined by the optical design.

One aspect of the disclosed embodiments relates to a lunar coronagraph that includes a primary mirror and a secondary mirror positioned on an optical axis and facing each other, wherein the primary mirror is positioned to receive moonlight in an on-axis configuration and to direct the received moonlight to the secondary mirror, the primary mirror including an opening in a center thereof to allow light that is reflected from the secondary mirror to exit therethrough, wherein a focal plane of the primary mirror is positioned at a location within the lunar coronagraph between the primary mirror and the secondary mirror. The lunar coronagraph also includes an occulting disk positioned at the focal plane of the primary mirror to block a portion of the moonlight corresponding to at least a portion of moon that is within a field of view of the lunar coronagraph, a mask positioned in an optical path after the occulting disk, the mask configured to block or reduce a diffraction artifact associated with the occulting disk, and a baffle positioned on the optical axis between the mask and the primary mirror to reduce or eliminate stray light associated with the moonlight that enters the lunar coronagraph.

In one example embodiment, the lunar coronagraph includes an imaging detector positioned at a focal plane of the secondary mirror to receive the light that exits the coronagraph through the center of the primary mirror. In another example embodiment, the primary mirror and the secondary mirror form a Gregorian telescope. In yet another example embodiment, the occulting disk is movably positioned at the focal plane of the primary mirror and is configured to laterally move in a plane perpendicular to the optical axis. In still another example embodiment, the lunar coronagraph includes a stepper motor coupled to the occulting disk to enable movement of the occulting disk in the focal plane. In one example embodiment, the baffle has a cross-sectional diameter such that the baffle does not block the moonlight that is directed from the primary mirror toward the secondary mirror.

According to another example embodiment, a length and a cross-sectional diameter of the baffle are selected in accordance with a focal length or f-number of the primary mirror. In another example embodiment, the baffle is shaped as a circular tube, and wherein one end of the circular tube is positioned at the opening in the center of the primary mirror, and another end of the circular tube is positioned less than halfway between the primary and the secondary mirrors. In still another example embodiment, the mask is a Lyot mask configured to mitigate one or more sidelobes of a point spread function (PSF) associated with the occulting disk.

In one example embodiment, the mask includes one or more features configured to mitigate diffraction effects associated with a structural support element of the lunar coronagraph. In another example embodiment, the structural support element includes spider vanes at an entrance of the lunar coronagraphs. In still another example embodiment, the lunar coronagraph includes one or more structural support elements configured to support one or more of the following: the primary mirror, the secondary mirror, the occulting disk or the mask. In yet another example embodiment, the one or more structural elements comprises three-dimensional (3D) printed composite material. In another example embodiment, the one or more structural elements comprises aluminum. In still another example embodiment, the one or more structural elements includes 80:20 aluminum.

According to another example embodiment, the lunar coronagraph includes an imaging detector, a processor coupled to the imaging detector, and a memory including instructions stored thereon. The instruction upon execution by the processor cause to processor to: receive signals or information from the imaging detector in response to detection of the light that exits the coronagraph, and process the signal or the information to produce one or more images of an object within a field of the lunar coronagraph. On one example embodiment, the object is detected at an angular distance of less than 3 degrees from the moon at a visual magnitude of greater than 18. In another example embodiment, the object is a satellite, a space craft, another terrestrial object, or a portion thereof. In still another example embodiment, the lunar coronagraph excludes any heat dissipation elements. In yet another example embodiment, the lunar coronagraph excludes any refractive optical elements in the optical path.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

It is understood that the various disclosed embodiments may be implemented individually, or collectively, in devices comprised of various optical components, electronics hardware and/or software modules and components. At least some of these devices, for example, may comprise or be coupled to a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes

Only a few implementations and examples are described and other implementations, enhancements and variations can be made based on what is described and illustrated in this patent document.

What is claimed is:

1. A lunar coronagraph, comprising:
a primary mirror and a secondary mirror positioned on an optical axis and facing each other, wherein the primary mirror is positioned to receive moonlight in an on-axis configuration and to direct the received moonlight to the secondary mirror, the primary mirror including an opening in a center thereof to allow light that is reflected from the secondary mirror to exit therethrough, wherein a focal plane of the primary mirror is positioned at a location within the lunar coronagraph between the primary mirror and the secondary mirror;
an occulting disk positioned at the focal plane of the primary mirror to block a portion of the moonlight corresponding to at least a portion of moon that is within a field of view of the lunar coronagraph;
a mask positioned in an optical path after the occulting disk, the mask configured to block or reduce a diffraction artifact associated with the occulting disk; and
a baffle positioned on the optical axis between the mask and the primary mirror to reduce or eliminate stray light associated with the moonlight that enters the lunar coronagraph.

2. The lunar coronagraph of claim 1, including an imaging detector positioned at a focal plane of the secondary mirror to receive the light that exits the coronagraph through the center of the primary mirror.

3. The lunar coronagraph of claim 1, wherein the primary mirror and the secondary mirror form a Gregorian telescope.

4. The lunar coronagraph of claim 1, wherein the occulting disk is movably positioned at the focal plane of the primary mirror and is configured to laterally move in a plane perpendicular to the optical axis.

5. The lunar coronagraph of claim 4, including a stepper motor coupled to the occulting disk to enable movement of the occulting disk in the focal plane.

6. The lunar coronagraph of claim 1, wherein the baffle has a cross-sectional diameter such that the baffle does not block the moonlight that is directed from the primary mirror toward the secondary mirror.

7. The lunar coronagraph of claim 1, wherein a length and a cross-sectional diameter of the baffle are selected in accordance with a focal length or f-number of the primary mirror.

8. The lunar coronagraph of claim 1, wherein the baffle is shaped as a circular tube, and wherein one end of the circular tube is positioned at the opening in the center of the primary mirror, and another end of the circular tube is positioned less than halfway between the primary and the secondary mirrors.

9. The lunar coronagraph of claim 1, wherein the mask is a Lyot mask configured to mitigate one or more sidelobes of a point spread function (PSF) associated with the occulting disk.

10. The lunar coronagraph of claim 1, wherein the mask includes one or more features configured to mitigate diffraction effects associated with a structural support element of the lunar coronagraph.

11. The lunar coronagraph of claim 10, wherein the structural support element includes spider vanes at an entrance of the lunar coronagraphs.

12. The lunar coronagraph of claim 1, including one or more structural support elements configured to support one or more of the following: the primary mirror, the secondary mirror, the occulting disk or the mask.

13. The lunar coronagraph of claim 12, wherein the one or more structural elements comprises three-dimensional (3D) printed composite material.

14. The lunar coronagraph of claim 12, wherein the one or more structural elements comprises aluminum.

15. The lunar coronagraph of claim 14, wherein the one or more structural elements includes 80:20 aluminum.

16. The lunar coronagraph of claim 1, comprising:
an imaging detector;
a processor coupled to the imaging detector; and
a memory including instructions stored thereon, wherein the instruction upon execution by the processor cause to processor to:
receive signals or information from the imaging detector in response to detection of the light that exits the coronagraph, and
process the signal or the information to produce one or more images of an object within a field of the lunar coronagraph.

17. The lunar coronagraph of claim 16, wherein the object is detected at an angular distance of less than 3 degrees from the moon at a visual magnitude of greater than 18.

18. The lunar coronagraph of claim 16, wherein the object is a satellite, a space craft, another terrestrial object, or a portion thereof.

19. The lunar coronagraph of claim 1, wherein the lunar coronagraph excludes any heat dissipation elements.

20. The lunar coronagraph of claim 1, wherein the lunar coronagraph excludes any refractive optical elements in the optical path.
